(19) United States
(12) Patent Application Publication
(10) Pub. No.: US 2019/0297211 A1
(43) Pub. Date: Sep. 26, 2019

(54) IMAGE FORMING APPARATUS AND CONTROL PROGRAM

(71) Applicant: Konica Minolta, Inc., Tokyo (JP)

(72) Inventor: Kazuto TANAKA, Ichikawa-shi (JP)

(21) Appl. No.: 16/284,604

(22) Filed: Feb. 25, 2019

(30) Foreign Application Priority Data
Mar. 20, 2018 (JP) 2018-053076

(51) Int. Cl. H04N 1/00; G06F 3/12

(52) U.S. Cl. CPC H04N 1/00694; H04N 1/00692; H04N 1/00724; G06F 3/1222; G06F 3/1258; H04N 1/00708; G06F 3/1205

(57) ABSTRACT

An image forming apparatus includes: a plurality of paper feed trays that feed accommodated sheets of paper; a detector that detects absence of paper in the paper feed trays; an image former that forms an image on a sheet of paper fed from one of the paper feed trays based on a print job; and a hardware processor that identifies a job attribute of the print job issued, selects a first tray switching condition or a second tray switching condition that is more lenient than the first tray switching condition in accordance with the job attribute identified, and in response to the detector detecting absence of paper in the paper feed tray in use during execution of the print job, switches to another paper feed tray that satisfies the tray switching condition selected.

The entire disclosure of Japanese patent Application No. 2018-053076, filed on Mar. 20, 2018, is incorporated herein by reference in its entirety.

### BACKGROUND

### Technological Field

The present invention relates to an image forming apparatus and a control program.

### Description of the Related Art

In a typical image forming apparatus, when paper absence (paper out) occurs while paper is continuously fed from a paper feed tray and conveyed for image formation, an auto tray switch (ATS) technique is used for switching to another paper feed tray accommodating paper of the same paper size as the paper feed tray in use.

In recent years, in the color printing industry, image forming apparatuses such as electrophotographic printers have been widely used. The field of production print (PP) in the color printing industry is required to adapt to a wider variety of paper than the field of office-use printing. In order to perform high-quality printing on a wide variety of paper, some image forming apparatuses specify the attribute of paper accommodated in paper feed trays in terms of a plurality of items, and perform printing under the image forming conditions corresponding to the specified setting items.

In a case where various types of paper are used, switching to another paper feed tray by ATS does not function effectively in many cases if switching is performed only when all the setting items of the paper feed tray in use strictly match those of another paper feed tray.

In order to solve such a problem, the printing apparatus disclosed in JP 2002-026444 A compares the paper attribute, e.g., paper size and paper type, of the paper feed tray that has run out of paper with the paper attribute of the other paper feed trays, and switches to the paper feed tray having the closest paper attribute. The printing apparatus of JP 2002-026444 A operates in this manner to activate the function of ATS in almost all cases. However, this printing apparatus is liable to switch to a paper feed tray that accommodates paper of an unexpected paper attribute. In order to solve such a problem of JP 2002-026444 A, the automatic tray selection program disclosed in JP 2010-201769 A refers to the allowable range set for each paper feed tray, and switches to another paper feed tray if the difference between the paper attribute of this paper feed tray and the paper attribute of the paper feed tray in use is within the allowable range. In this manner, JP 2010-201769 A widens the allowable range of ATS so that ATS functions effectively, and suppresses the use of unexpected paper.

However, J P 2010-201769 A sets the allowable range of the paper attribute for each paper feed tray, and thus cannot switch the ATS switching condition according to the user issuing a print job, which causes the problem of inferior usability.

### SUMMARY

The present invention has been made in view of the above circumstances, and an object thereof is to provide an image forming apparatus excellent in usability and a control program.

To achieve the abovementioned object, according to an aspect of the present invention, an image forming apparatus reflecting one aspect of the present invention comprises: a plurality of paper feed trays that feed accommodated sheets of paper; a detector that detects absence of paper in the paper feed trays; an image former that forms an image on a sheet of paper fed from one of the paper feed trays based on a print job; and a hardware processor that identifies a job attribute of the print job issued, selects a first tray switching condition or a second tray switching condition that is more lenient than the first tray switching condition in accordance with the job attribute identified, and in response to the detector detecting absence of paper in the paper feed tray in use during execution of the print job, switches to another paper feed tray that satisfies the tray switching condition selected.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is an overall configuration diagram of an image forming apparatus;

FIG. 2 is a block diagram illustrating a hardware configuration of the image forming apparatus;

FIG. 3 is a block diagram illustrating a functional configuration of a controller;

FIG. 4 is a diagram illustrating a second type simple setting screen;

FIG. 5 is a diagram illustrating a second type setting screen;

FIG. 6 is a diagram illustrating a second type setting screen;

FIG. 7 is a diagram illustrating a first type detailed setting screen;

FIG. 8 is a diagram illustrating a first type setting screen;

FIG. 9 is a diagram illustrating a first type setting screen;

FIG. 10 is a diagram illustrating a second type setting screen;

FIG. 11 is a diagram illustrating a first type setting screen;

FIG. 12 is a diagram illustrating a setting screen;

FIG. 13 is a diagram illustrating a second type setting screen;

FIG. 14 is a diagram illustrating a first type setting screen;

FIG. 15 is a main flowchart illustrating ATS processing;

FIG. 16 is a subroutine flowchart relating to selection of a switching condition in step S15 of FIG. 15;

FIG. 17 is a diagram illustrating a setting screen for setting a job attribute;

FIG. 18 is a diagram illustrating an example of a user list;

FIG. 19A is a subroutine flowchart relating to paper feed tray switching control in step S16 of FIG. 15;

FIG. 19B is a subroutine flowchart following FIG. 19A;

FIGS. 20A to 20C are diagrams illustrating setting screens displayed in the event of paper absence;

FIG. 21 is a table illustrating items related to paper information and classifications thereof;

FIG. 22 is an example of a confirmation screen displayed in the event of paper absence;

FIG. 23 is an example of a confirmation screen displayed in the event of paper absence;

FIG. 24 is a subroutine flowchart following FIG. 16;

FIG. 25 is a diagram illustrating a setting screen for setting a job attribute;

FIG. 26 is a subroutine flowchart relating to history management in step S17 of FIG. 15; and

FIG. 27 is a diagram illustrating an example of history data.

### DETAILED DESCRIPTION OF EMBODIMENTS

Hereinafter, one or more embodiments of the present invention will be described with reference to the drawings. However, the scope of the invention is not limited to the disclosed embodiments. In the description of the drawings, identical elements are denoted by the same reference signs, and duplicate descriptions are omitted. The dimensional ratios of the drawings are exaggerated for convenience of explanation and may differ from the actual ratio.

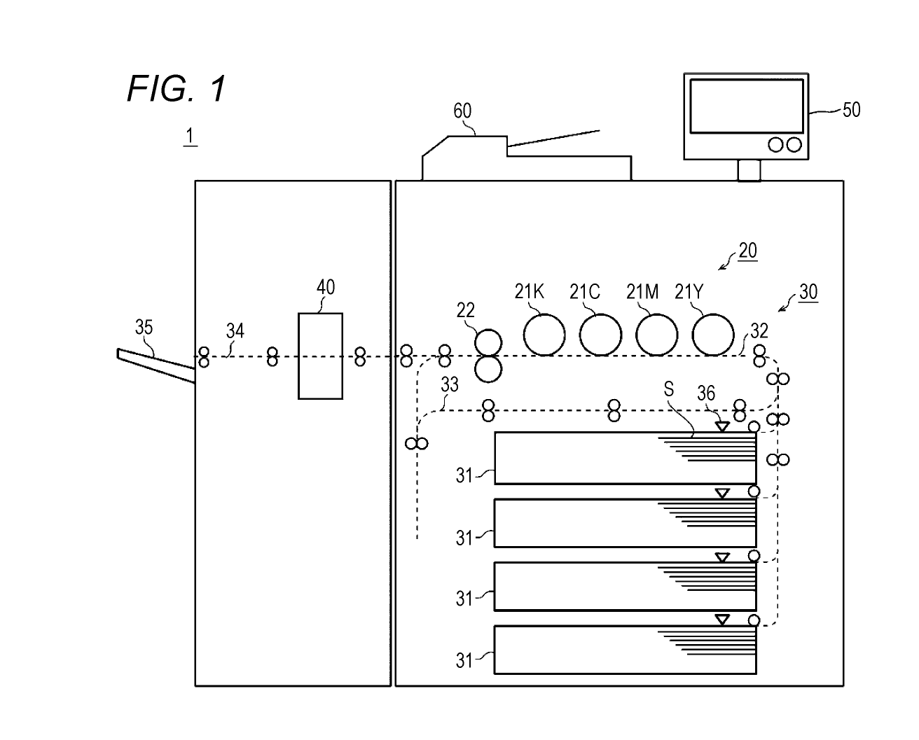

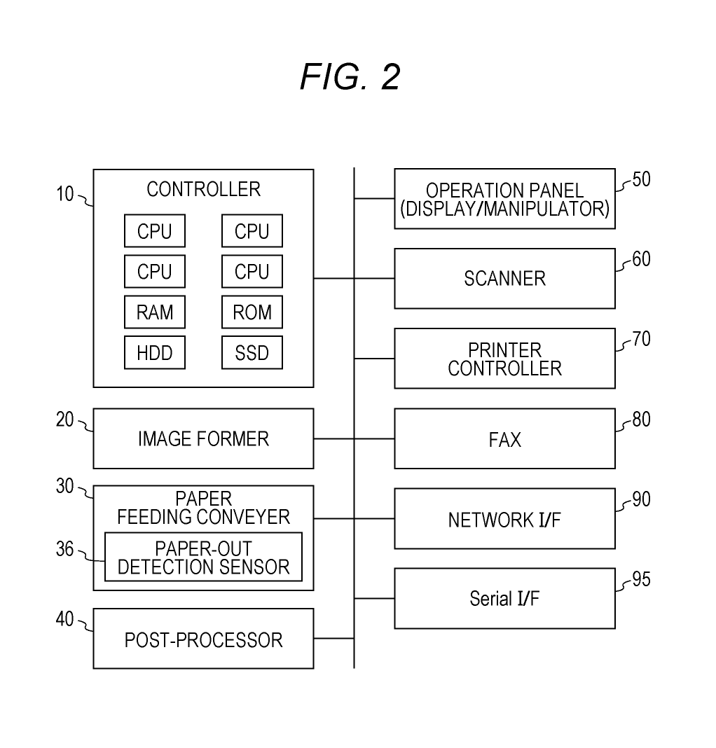

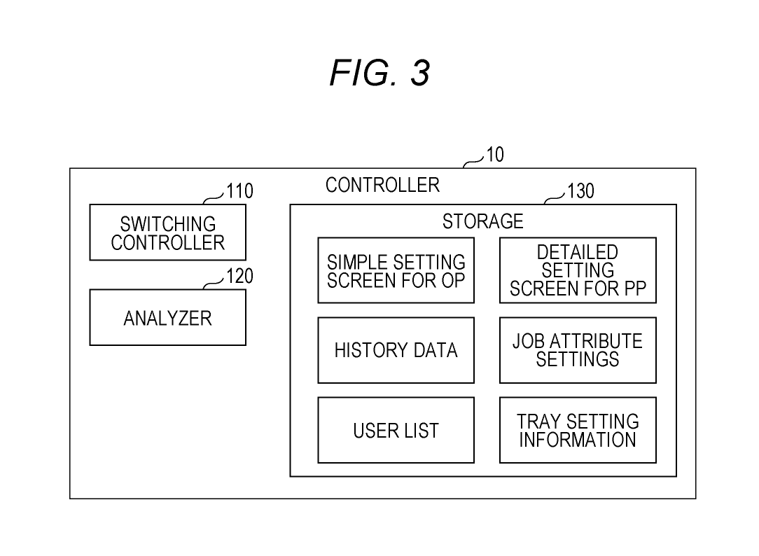

FIG. 1 is an overall configuration diagram of an image forming apparatus according to an embodiment of the present invention. FIG. 2 is a block diagram illustrating a hardware configuration of the image forming apparatus. FIG. 3 is a block diagram illustrating a functional configuration of a controller.

As illustrated in FIGS. 1 and 2, the image forming apparatus 1 includes the controller 10, an image former 20, a paper feeding conveyer 30, a post-processor 40, an operation panel 50, a scanner 60, a printer controller 70, a FAX 80, a network interface (I/F) 90, and a serial I/F 95. These components are connected to one another via a bus for exchanging signals.

The controller 10 includes a plurality of central processing units (CPUs), a random access memory (RAM), a read only memory (ROM), a hard disk drive (HDD), a solid state drive (SSD), and the like. Data processed by the controller 10 are temporarily stored in the RAM. The ROM stores various programs and various data. The HDD and the SSD function as a storage 130 (see FIG. 3). The storage 130 stores various programs including a program for controlling each component of the image forming apparatus 1, print data from outside sent through the network I/F 90, image data obtained through the scanner 60, a table indicating various types of setting information, and other various data. It is to be noted that the storage 130 may not be physically within the main body of the image forming apparatus 1, but may be provided in a file server on the network, for example.

The image former 20 forms an image on a sheet S by a well-known electrophotographic process using toner. The image former 20 includes imagers 21Y, 21M, 21C, and 21K and a fixer 22. The imagers 21Y, 21M, 21C, and 21K correspond to the basic colors of yellow (Y), magenta (M), cyan (C), and black (K), respectively. Toner images of the respective colors are sequentially transferred to the sheet S being conveyed. The toner images are heated and pressurized by the fixer 22 on the downstream side and fixed on the surface of the sheet S.

The paper feeding conveyer 30 includes a plurality of paper feed trays 31, paper conveyance paths 32, 33, and 34, a paper discharge tray 35, a paper-out detection sensor 36, and the like. Each paper feed tray 31 is provided with a lift plate on which sheets of paper are placed, a width-direction restriction plate, and a rear-end restriction plate. The lift plate is moved up and down such that the upper end of a bundle of sheets placed on the lift plate has a predetermined height. The position information of the lift plate is acquired by an encoder attached to the rotation shaft of the motor that moves up and down the lift plate, whereby the remaining amount of paper is detected. When replenishing the paper feed tray 31 with paper, the user moves the position of each restriction plate according to the paper size. By detecting the position of each restriction plate with an optical sensor or the like, the size of the loaded paper is detected. The paper feed tray 31 may be arranged in the main body of the apparatus as illustrated in FIG. 1. Alternatively, an external paper feed device may be provided adjacent to the main body of the apparatus, and the paper feed tray 31 may be arranged in the external paper feed device.

Each paper feed tray 31 accommodates a plurality of sheets S, and feeds the uppermost sheet S one by one with a provided paper feed roller. A plurality of pairs of conveyance rollers are arranged along the paper conveyance paths 32 to 34, and these pairs of conveyance rollers are driven by a driver (not illustrated). The paper feeding conveyer 30 feeds the sheet S fed from the paper feed tray 31 to the image former 20 along the paper conveyance path 32, and conveys the sheet S with an image formed thereon to the paper discharge tray 35 through the paper conveyance path 34 on the downstream side. In the case of duplex printing, the sheet S with an image formed on one side thereof is conveyed to the paper conveyance path 33 for duplex printing at the lower part of the main body of the apparatus. The sheet S conveyed to the paper conveyance path 33 is inverted by a switchback path and returned to the paper conveyance path 32 for one-side printing, and the image former 20 again forms an image on the other side of the sheet S.

The loss of the sheets S accommodated in each paper feed tray 31 is detected by the paper-out detection sensor 36 functioning as a detector. The paper-out detection sensor 36 is an optical type sensor including, for example, a light emitter and a light receiver.

The post-processor 40 is provided in the paper conveyance path 34. The post-processor 40 performs, for example, binding processing, and has a stacker that stacks sheets and a stapler. After a plurality of sheets S is stacked on the stacker, stapling processing is performed by the stapler using staples.

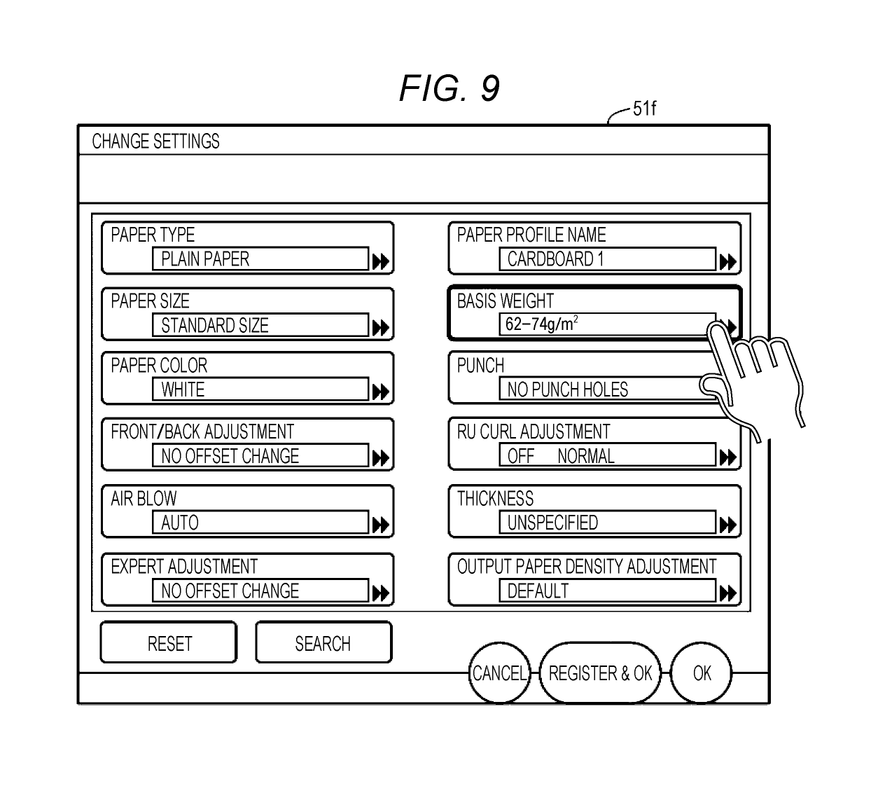

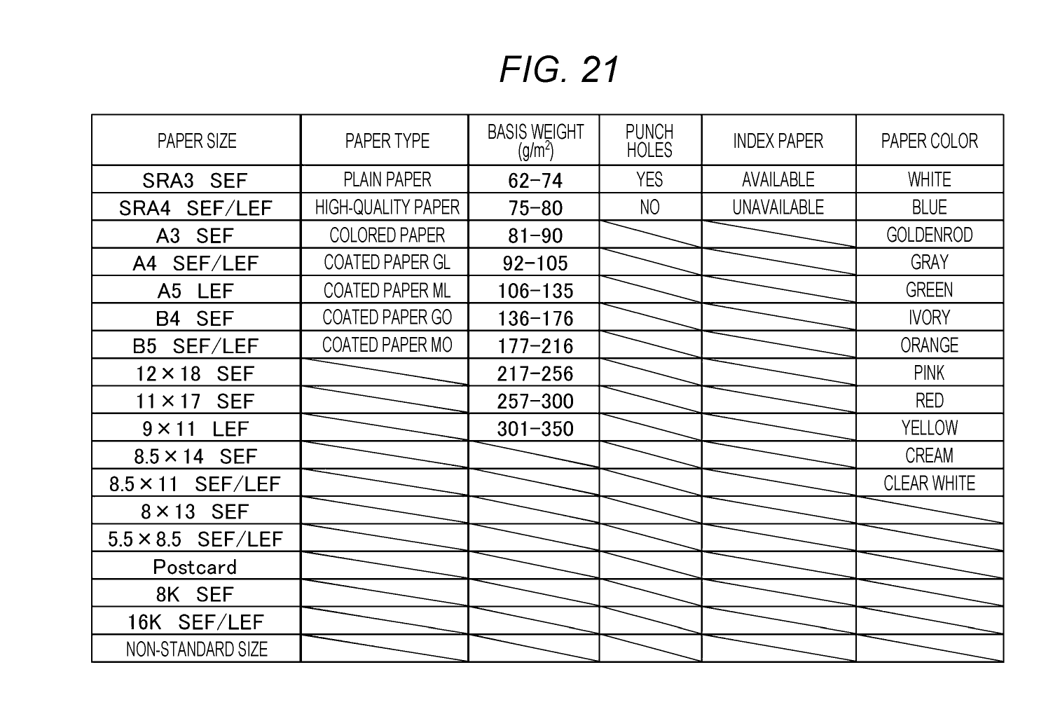

The operation panel 50 includes a touch panel, a numeric keypad, a start button, a stop button, and the like, and functions as a display and a manipulator. The operation panel is used for input of various settings such as printing conditions, display of the state of the apparatus, and input of various instructions. The user can input paper information of paper loaded in the paper feed tray 31 through the operation panel 50 as described later. Paper information includes the type of paper (plain paper, coated paper, hole punched paper, index paper, and colored paper), the thickness, basis weight, and size of paper, and the like (see FIGS. 9 and 21 described later). The input paper information is stored in the storage 130 of the controller 10 in association with the paper feed tray 31.

The scanner 60 is provided at the upper part of the main body of the apparatus, and reads a document to generate image data.

The printer controller 70 performs layout processing and rasterizing processing on print data included in a print job received by the network I/F 90, and generates image data which are bitmap image data. A print job includes print data and job settings. Print data are data of a document to be printed. Print data include various data such as image data, vector data, and text data, for example. More specifically, print data are page description language (PDL) data, portable document format (PDF) data, or tagged image file format (TIFF) data. “Job settings” are settings relating to image formation including paper information, settings relating to the number of output copies and the number of sheets per copy, and settings relating to post-processing for printed materials. For example, job settings include various settings such as the type of paper, gray scale or full color, 2-in-1, duplex printing, stapling, punching, and folding.

The FAX 80 has a modem and the like, and connects to a telephone network such as a public line or a private branch exchange via a telephone line to exchange data with an external terminal.

The network I/F 90 is an interface for various local connections such as a network interface for wired communication under the standard of Ethernet (registered trademark) and the like and an interface for wireless communication under the standard of Bluetooth (registered trademark), IEEE 802.11, and the like. The network I/F 90 communicates with a user terminal such as a personal computer (PC) connected to the network.

The serial I/F 95 is an interface for serial communication under the standard of RS-232C, IEEE 1394, USB, and the like, and communicates with various terminals.

As illustrated in FIG. 3, the functions of the controller 10 include a switching controller 110, an analyzer 120, and the storage 130. The switching controller 110 performs ATS, and performs switching control for the paper feed tray 31 when paper absence (paper out) occurs. The switching controller 110 also analyzes the issued print job and identifies the job attribute. More specifically, the switching controller 110 identifies the issued print job as a print job issued by a user who uses a production print (PP) machine (hereinafter referred to as a “user for PP”) or a print job issued by a user who uses an office product (OP) machine (hereinafter referred to as a “user for OP”) using any one of “user information”, “setting screen type”, and “job setting” as the job attribute. Regarding ATS processing, the present embodiment is based on the assumption that users for PP are strict in quality management and desire to switch only to paper with matching paper information. The present embodiment is also based on the assumption that users for OP are not so strict in quality management and allow switching to paper that matches the paper in use only in paper size but does not match the paper in use in other items of paper information such as basis weight.

The analyzer 120 accumulates history data relating to completed print jobs, analyzes the history data, and automatically sets a threshold value of the number of copies and a threshold value of the number of pages per copy which are used for identification of the job attribute to be described later.

The storage 130 stores a simple setting screen for OP, a detailed setting screen for PP, history data of print jobs, job attribute settings, a user list, paper type tray setting information related to the paper attribute of sheets accommodated in each paper feed tray 31, and the like. Below is a detailed description of these items.

The detailed setting screen is a setting screen for PP which enables detailed settings regarding paper information based on the premise of a dedicated operator's operation. On the other hand, the simple setting screen is a setting screen having simpler setting items related to paper information and the like than the detailed screen so as to be operated by ordinary users. More specifically, for example, the “detailed setting screen” is a screen configuration that can be efficiently operated by a user accustomed to the operation, and can often be implemented from one screen. Since it is important to enable high-quality printing for various types of paper, for example, the paper type/tray selection occupies a large area of the copy screen for copy settings. On the other hand, the “simple setting screen” is a simplified screen configuration that can be easily operated by a user who is not accustomed to the operation, and the output image representation occupies a large area of its copy screen (default). Since the user does not much care about the type of paper, there is little information about the type of paper. In the following description, the detailed setting screen and the simple setting screen are referred to as the first type and second type setting screens, respectively.

Generally, paper information settings are configured using the first type detailed setting screen in the apparatus for PP and using the second type simple setting screen in the apparatus for OP. The first type detailed setting screen and the second type simple setting screen are rarely used in combination. The image forming apparatus 1 according to the present embodiment is an apparatus for PP. However, in order to make it easy for an ordinary user who is accustomed to the operation of an apparatus for OP (not a dedicated operator) to use the image forming apparatus 1, the detailed setting screen and the simple setting screen are used in combination. In the following explanation, each of the second type and first type setting screens will be explained first, and the operation of switching between the two setting screens will then be explained.

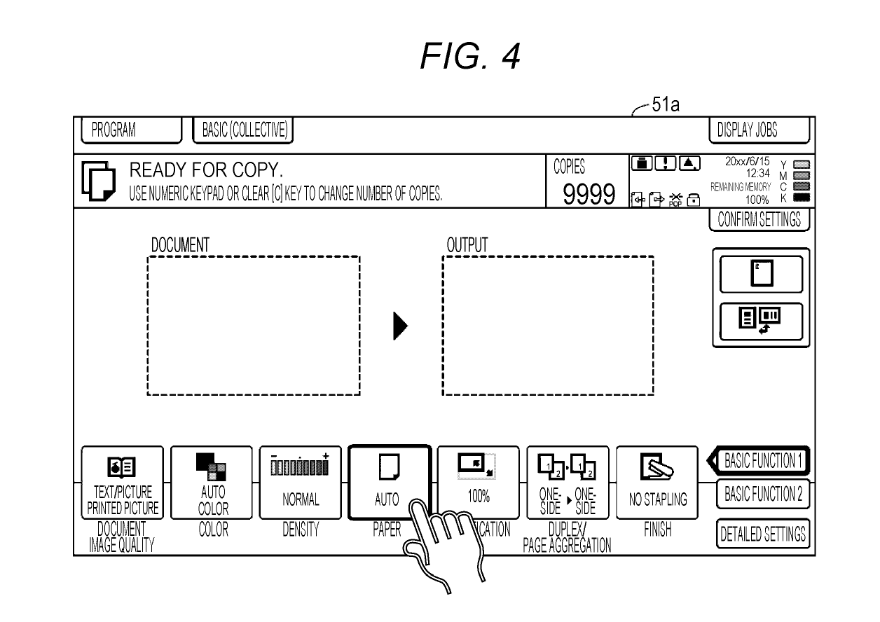

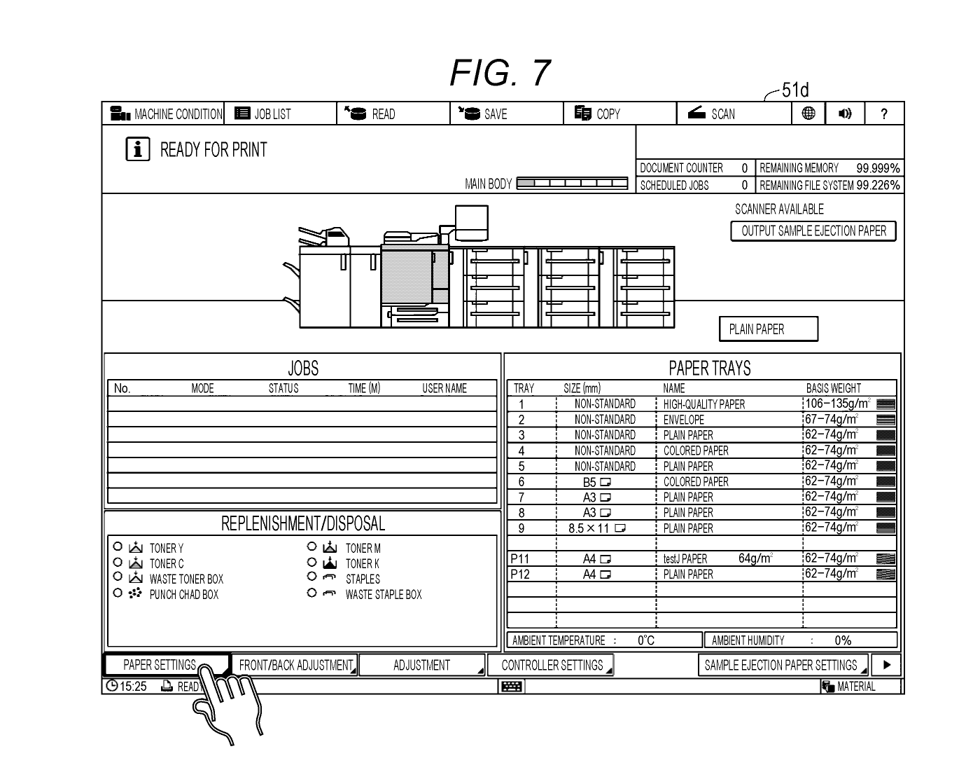

FIGS. 4 to 6 are examples of the second type setting screens, and FIGS. 7 to 9 are examples of the first type setting screens. The following description is based on the assumption that various screens including these setting screens are displayed on the operation panel 50. Alternatively, various screens may be displayed on the screen of a user terminal (PC).

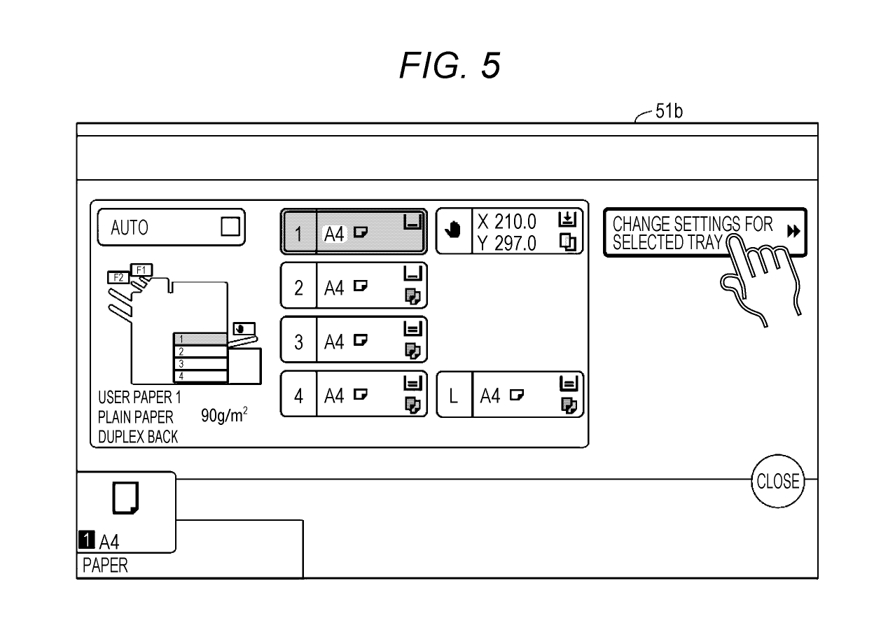

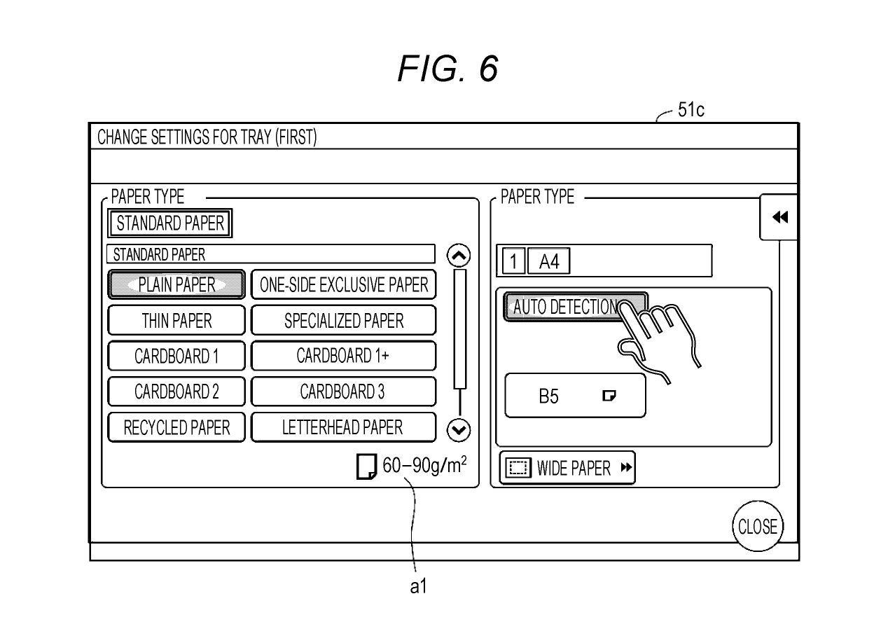

When setting the paper information of the paper feed tray 31 on the second type setting screen, the user presses the button “paper” on a basic setting screen 51a illustrated in FIG. 4 (in the figure, the button to be operated is indicated by a hand (the same applies hereinafter)). Thus, a setting screen 51b of FIG. 5 is displayed. In this setting screen 51b, the paper feed tray 31 to be set is selected. In the example of the figure, the uppermost paper feed tray 31 is selected. By pressing the button “change settings for selected tray” on this setting screen 51b, a setting screen 51c of FIG. 6 is displayed.

On the setting screen 51c of FIG. 6, automatic detection of the paper size is performed by pressing the button “auto detection”. On the setting screen 51c, B5 size is detected. The user also selects the paper type. When “plain paper” is selected as the paper type, the basis weight is set to the default value “60-90 g/m²” as illustrated in the field a1. In this way, on the simple setting screen, the user can set paper information without being conscious of the basis weight.

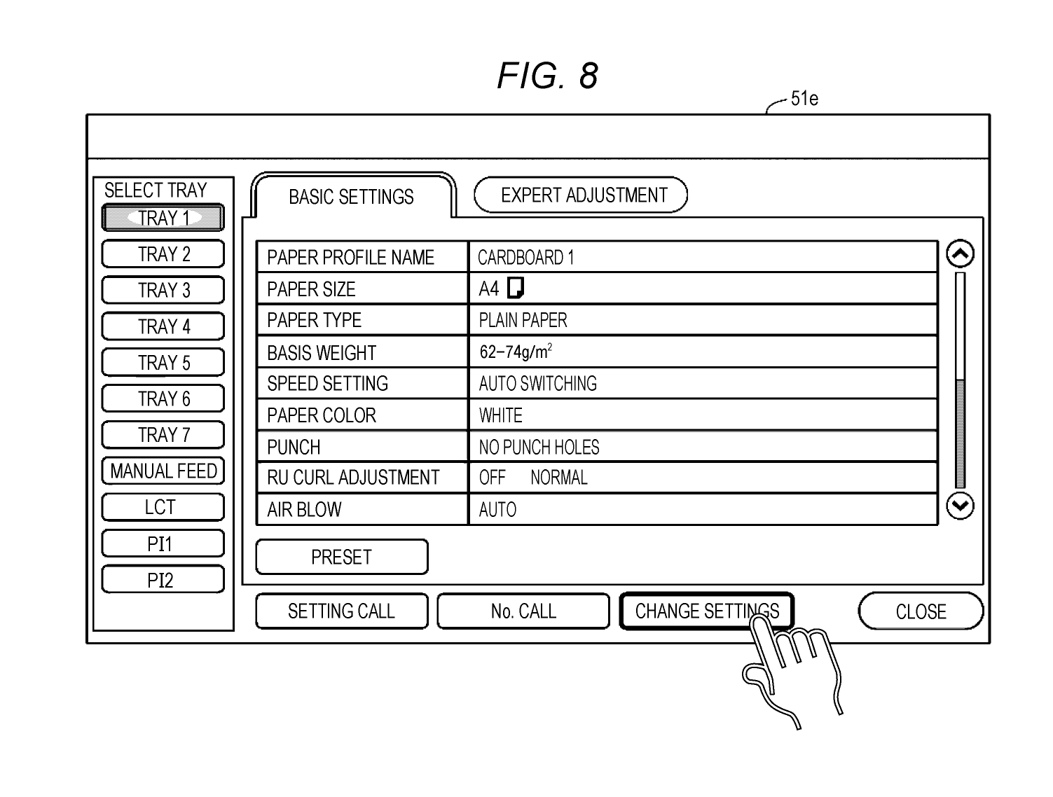

When setting the paper information of the paper feed tray 31 on the first type detailed setting screen, the user presses the button “paper settings” on a setting screen 51d indicating the machine condition illustrated in FIG. 7. As a result, a setting screen 51e of FIG. 8 is displayed. On the setting screen 51e, the user selects the paper feed tray 31 to be set. In the example of the figure, the uppermost paper feed tray 31 is selected. By pressing the button “change settings” on this setting screen 51e, a setting screen 51f of FIG. 9 is displayed. This setting screen allows the user to set a plurality of items related to paper information such as paper type, paper size, front/back adjustment, and basis weight. For example, by selecting the button “basis weight”, the basis weight can be set. When the user presses the button “register & OK” after selecting the settings, the paper information is registered and stored in the storage 130 as tray setting information (“tray setting information” in FIG. 3). In this way, on the detailed setting screen, the user configures settings while being conscious of each item relating to paper information including basis weight.

Next, the transition between the detailed setting screen and the simple setting screen, that is, the transition between the first type and second type setting screens will be described.

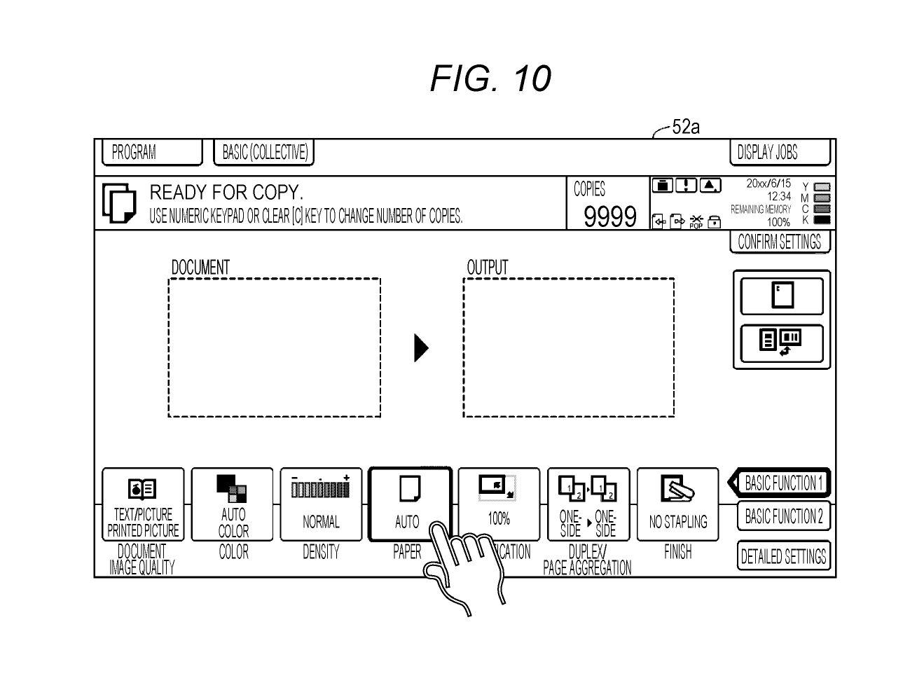

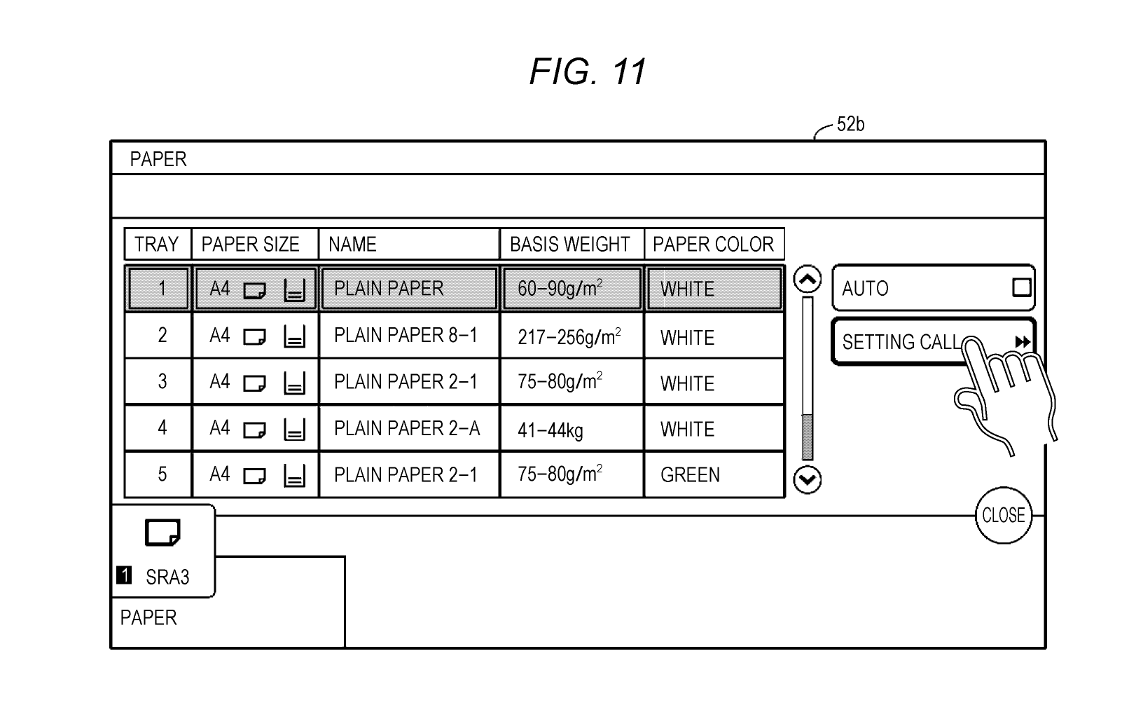

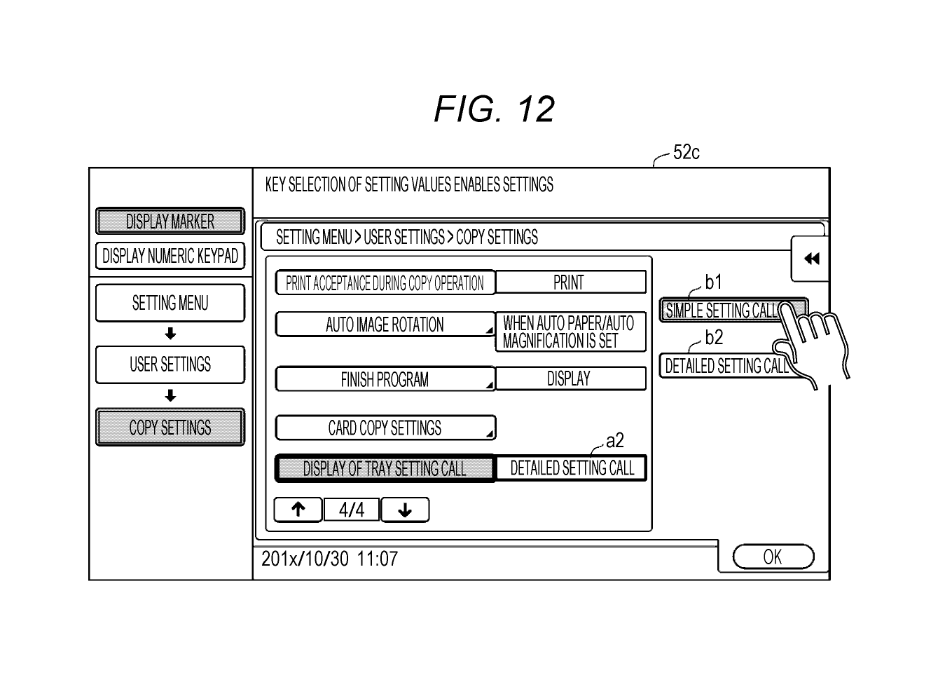

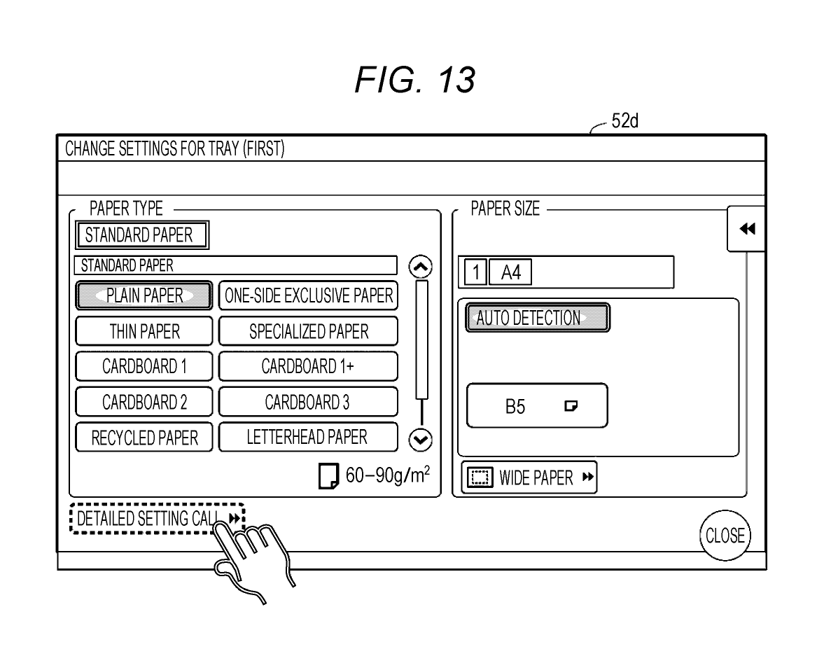

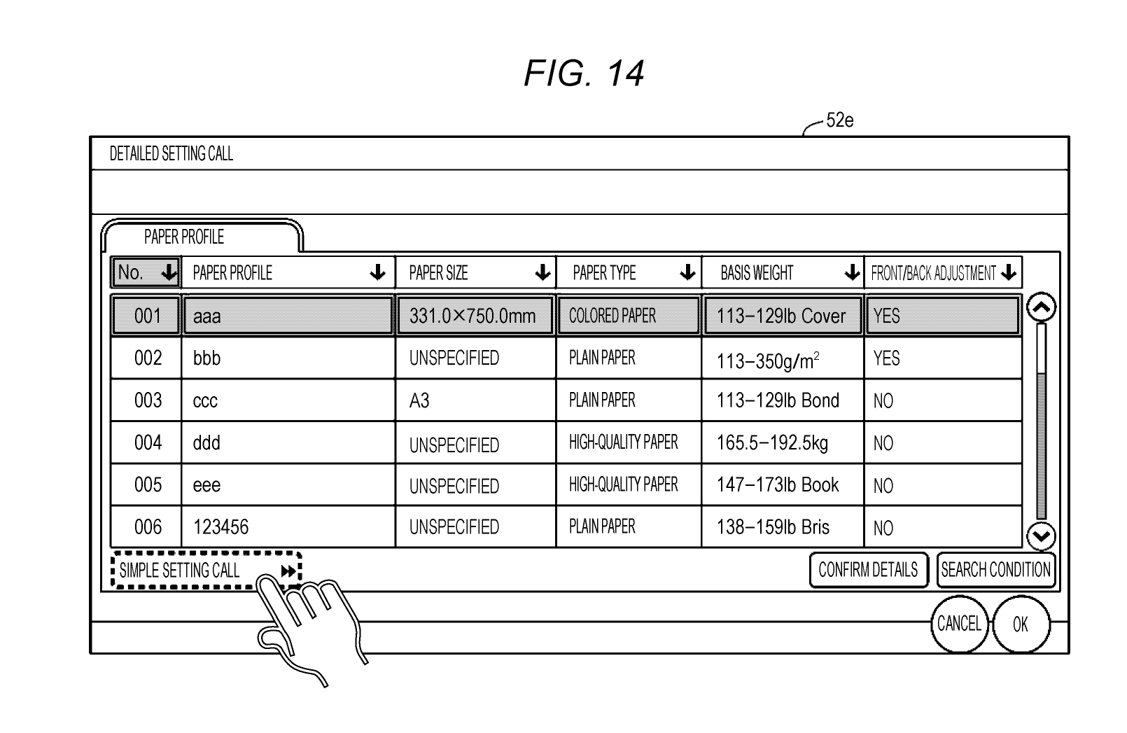

FIG. 10 is a second type setting screen 52a according to another example similar to the setting screen 51a illustrated in FIG. 4. By pressing the button “paper” on this setting screen 52a, a second type detailed setting screen 52b of FIG. 11 is displayed. A setting screen 52c in FIG. 12 is a screen for selecting the detailed setting screen and the simple setting screen to be used, and a screen for the transition from a setting screen different from the above setting screen. On this setting screen 52c, the user can change “display of tray setting call” in the field a2 from “detailed setting call” to “simple setting call” by pressing the button b1 “simple setting call”, and the change is confirmed by pressing the “OK” button. For example, a second type setting screen 52d in FIG. 13 is displayed. The setting screen 52d is also displayed by pressing the button “setting call” on the setting screen 52b of FIG. 11. By pressing the button “detailed setting call” on the setting screen 52d in FIG. 13, a first type setting screen 52e illustrated in FIG. 14 is displayed. The second type setting screen 52d of FIG. 13 is also displayed by pressing the button “simple setting call” on the first type setting screen 52e of FIG. 14.

On the first type setting screen 52e, for example, up to 500 sets of paper setting information can be registered. The user selects the paper profile that the user wishes to use on this setting screen 52e and presses the OK button, whereby the setting information of each paper feed tray 31 is updated. Note that the registration of a new paper profile itself can be performed on another setting screen (not illustrated). When the paper type information of the paper feed tray 31 is set on the second type setting screen 52d as illustrated in FIG. 13, the paper type information and the use of the second type setting screen are associated with each paper feed tray 31 and stored in the storage 130. Similarly, when the paper type information of the paper feed tray 31 is set on the first type setting screen 52e as illustrated in FIG. 14, the paper type information and the use of the first type setting screen are associated with each paper feed tray 31 and stored in the storage 130.

(Control Flow)

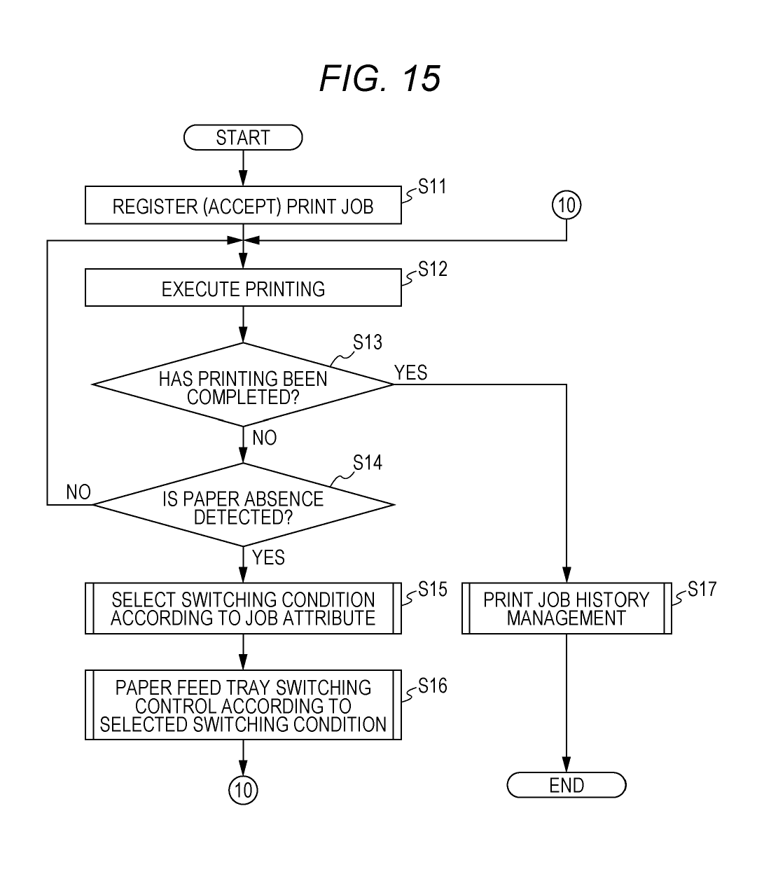

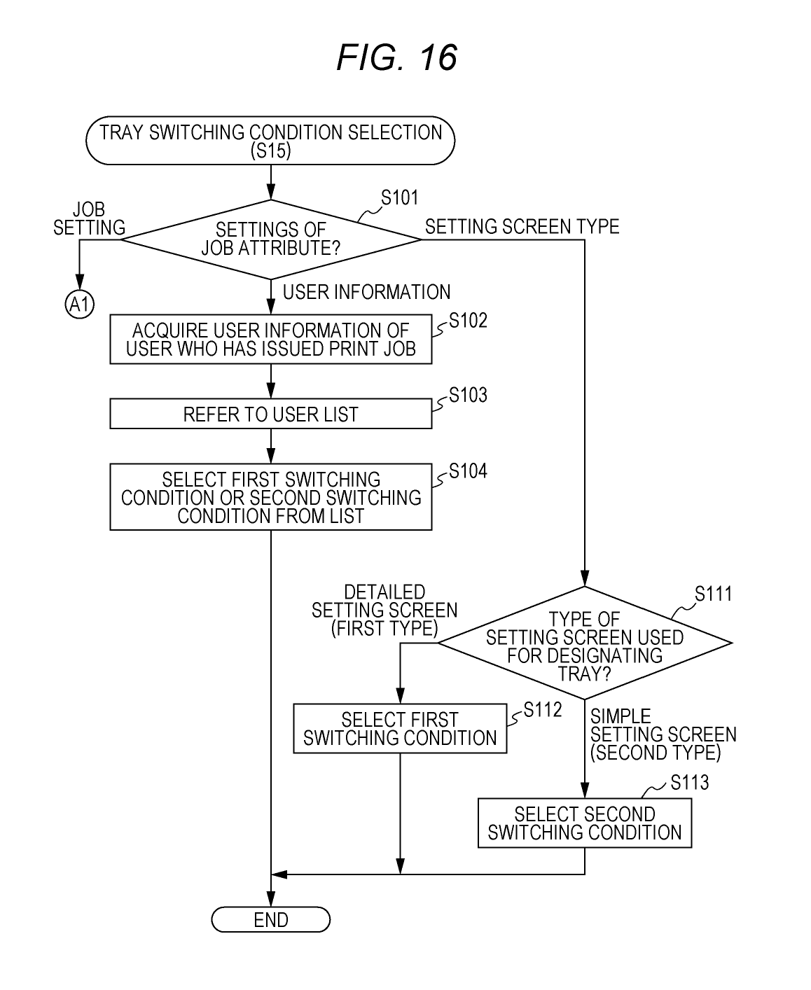

Hereinafter, ATS processing that is performed by the controller 10 (switching controller 110) of the image forming apparatus 1 at the time of executing a print job will be described with reference to FIGS. 15 to 27. FIG. 15 is a main flowchart illustrating ATS processing, and FIGS. 16, 19A, 19B, 24, and 26 are subroutine flowcharts. In the present embodiment, the user who has issued a print job to the image forming apparatus 1 is identified, using the job attribute of the print job, as a user for PP who configures detailed settings for paper or a user for OP who is not conscious of the basis weight of paper or the like. Then, ATS processing is performed according to the identification result.

(Step S11)

First, the controller 10 accepts the registration of a print job from the user. For example, the user inputs a print job together with authentication information from the user terminal into the image forming apparatus 1. Alternatively, after user authentication is performed by key input of authentication information from the operation panel 50 or by data transfer using an IC card reader (not illustrated), the registration of a print job through operation on the operation panel is accepted. The authentication information includes, for example, a user ID and a password.

(Step S12)

The print job input in step S11 is executed. Specifically, the sheet S is fed from the paper feed tray 31 selected according to the job settings configured in the print job, and an image is formed by the image former 20.

(Step S13)

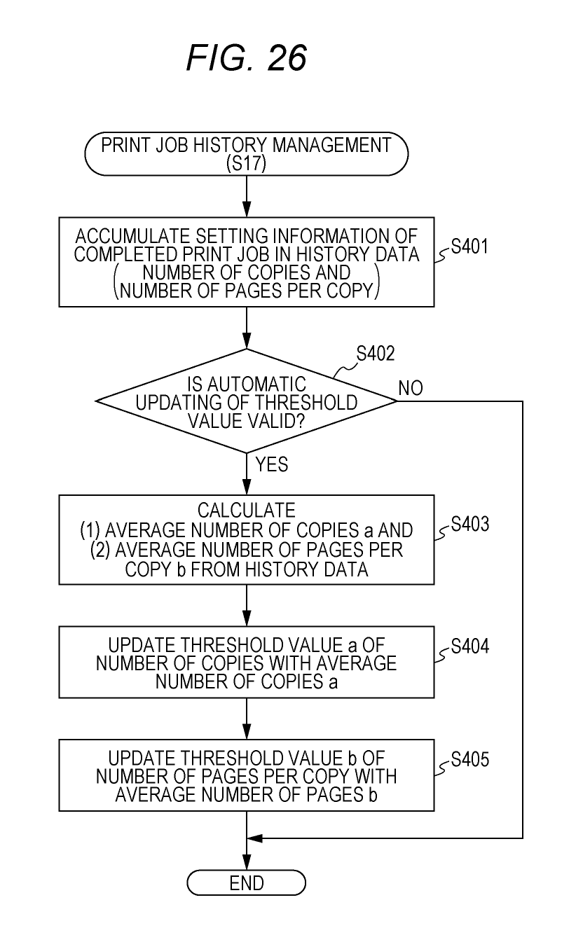

If printing of the print job has not been completed (NO), the processing proceeds to step S14. On the other hand, if printing of the print job has been completed (YES), the processing proceeds to step S17. Step S17 for print job history management will be described later (FIG. 26 to be described later).

(Step S14)

If the paper-out detection sensor 36 does not detect paper absence (paper out) in the paper feed tray 31 in use (NO), the controller 10 returns the processing to step S12. On the other hand, if the paper-out detection sensor 36 detects paper absence (YES), the print job is interrupted, and the processing proceeds to step S15 concerning the process of selecting the tray switching condition.

(Step S15 (Selection of Switching Condition According to Job Attribute))

FIG. 16 is a subroutine flowchart for step S15. In the subroutine flowchart of FIG. 16, the switching controller 110 determines whether the print job has been issued by a user for PP or issued by a user for OP according to the settings of the job attribute. Then, if the print job has been issued by a user for PP, the first switching condition is selected, and if the print job has been issued by a user for OP, the second switching condition is selected.

(Step S101)

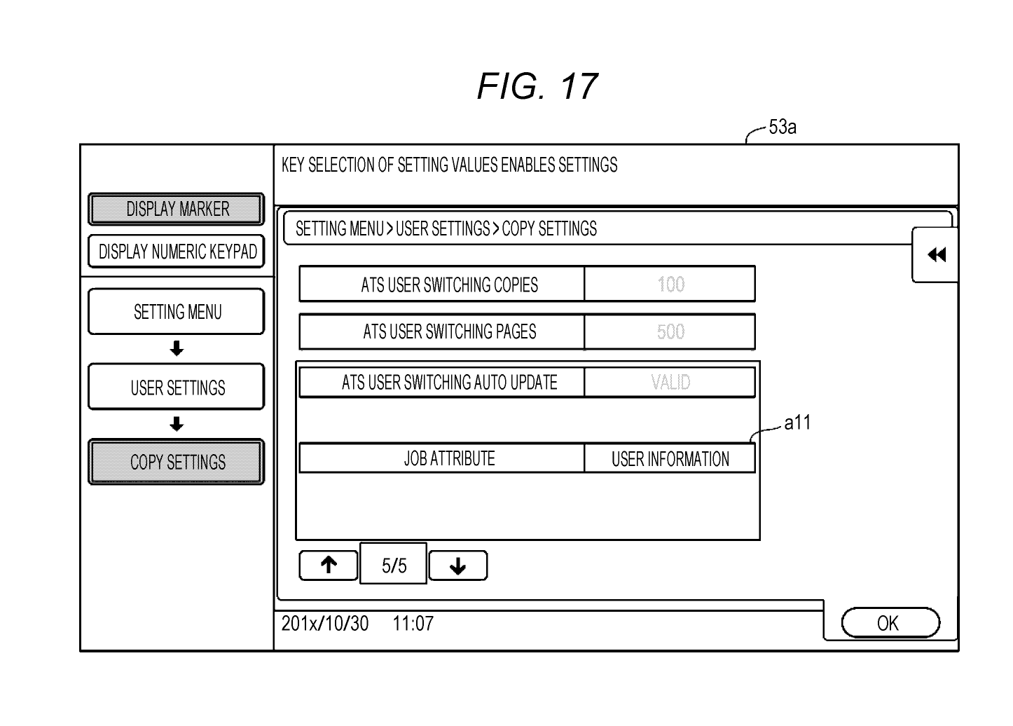

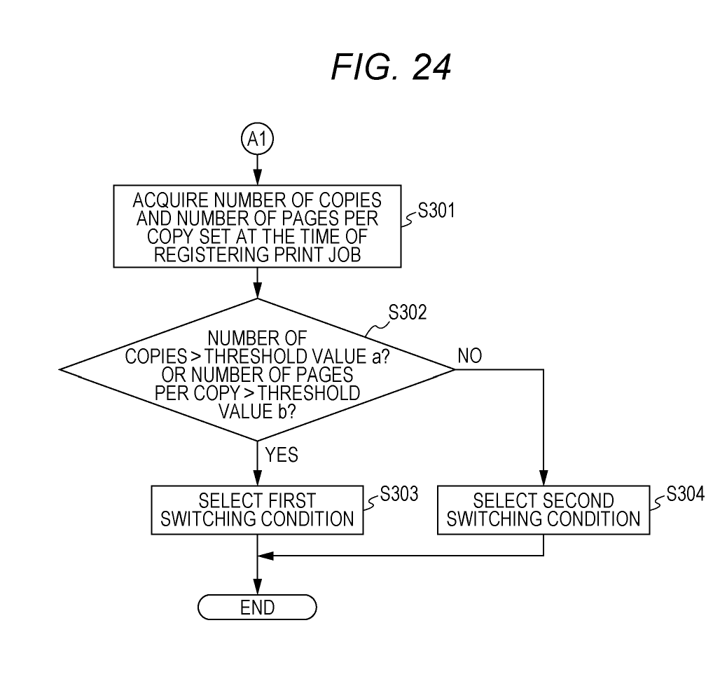

In step S101 of FIG. 16, the switching controller 110 determines the settings of the job attribute of the print job accepted in step S11. The settings of the job attribute can be configured on a setting screen 53a of FIG. 17. By operating the field all, the user can select one of “user information”, “setting screen type”, and “job setting” with respect to the settings of the job attribute. The job attribute set by selection is stored in the storage 130. If “user information” is set as in the example of the setting screen 53a in FIG. 17, the processing proceeds to step S102. Alternatively, if “setting screen type” is set, the processing proceeds to step S111. If “job setting” is set, the processing proceeds to step S301 in FIG. 24. Hereinafter, the cases where “user information” and “setting screen type” are set as the job attribute will be described in order, and the case where “job setting” is set as the remaining job attribute will be described later (FIG. 24).

(Step S102)

The switching controller 110 acquires the user information (user ID) of the user who has issued the print job. The user information is included in the authentication information acquired at the time of registering the print job at step S11.

(Step S103)

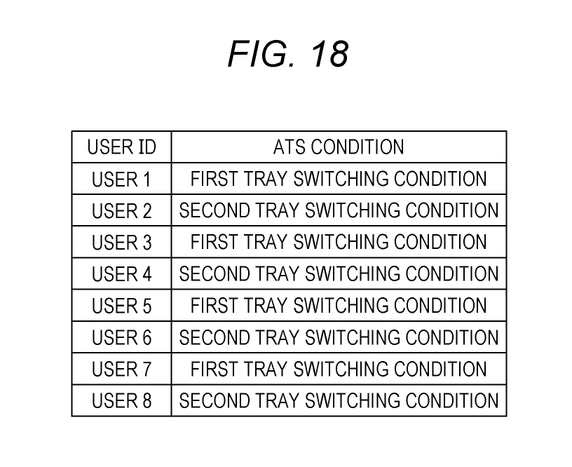

The switching controller 110 then refers to a user list. FIG. 18 is a diagram illustrating an example of a user list. As illustrated in FIG. 18, the user list describes the correspondence relationship between user information (user IDs) and tray switching conditions, which is stored in advance in the storage 130. This user list can be changed and added via the operation panel 50 or the like by a user having administrator authority for the image forming apparatus 1. For example, the first tray switching condition is set for a user for PP, and the second tray switching condition is set for a user for OP.

(Step S104)

By referring to the user list, the switching controller 110 selects the switching condition based on the user information of the user who has input the print job. For example, if the user ID is “user 1” in FIG. 18, the “first tray switching condition” is selected. After that, the processing of the subroutine flowchart is ended, and the flow returns to the main routine flowchart of FIG. 15.

(Step S111)

Next, the processing for the case where the “setting screen type” is set as the “job attribute” will be explained. The switching controller 110 determines the type of the setting screen used at the time of registering the print job and used for designating the paper information of the paper feed tray 31 that has run out of paper. If the paper information of the used paper feed tray 31 has been set using the above-mentioned detailed first type setting screens of FIGS. 8, 9, and 14, the processing proceeds to step S112.

On the other hand, if paper information has been set using the second type setting screens of FIGS. 5, 6, and 13 which are simpler than the first type setting screens, the processing proceeds to step S113. This is because the user using the first type setting screen can be presumed to be a user for PP, and the user using the second type setting screen can be presumed to be a user for OP who is not conscious of paper information other than the paper size such as the basis weight.

(Step S112)

The switching controller 110 selects the first switching condition. After that, the processing of the subroutine flowchart is ended, and the flow returns to the main routine flowchart of FIG. 15.

(Step S113)

The switching controller 110 selects the second switching condition. After that, the processing of the subroutine flowchart is ended, and the flow returns to the main routine flowchart of FIG. 15.

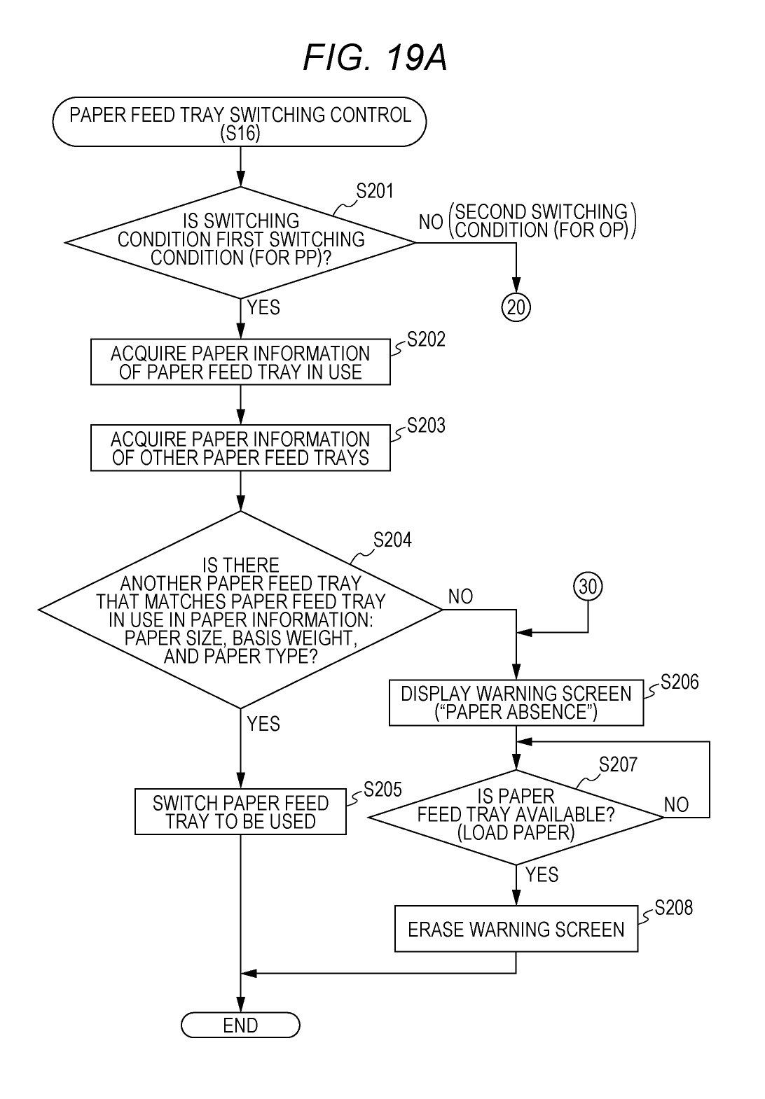

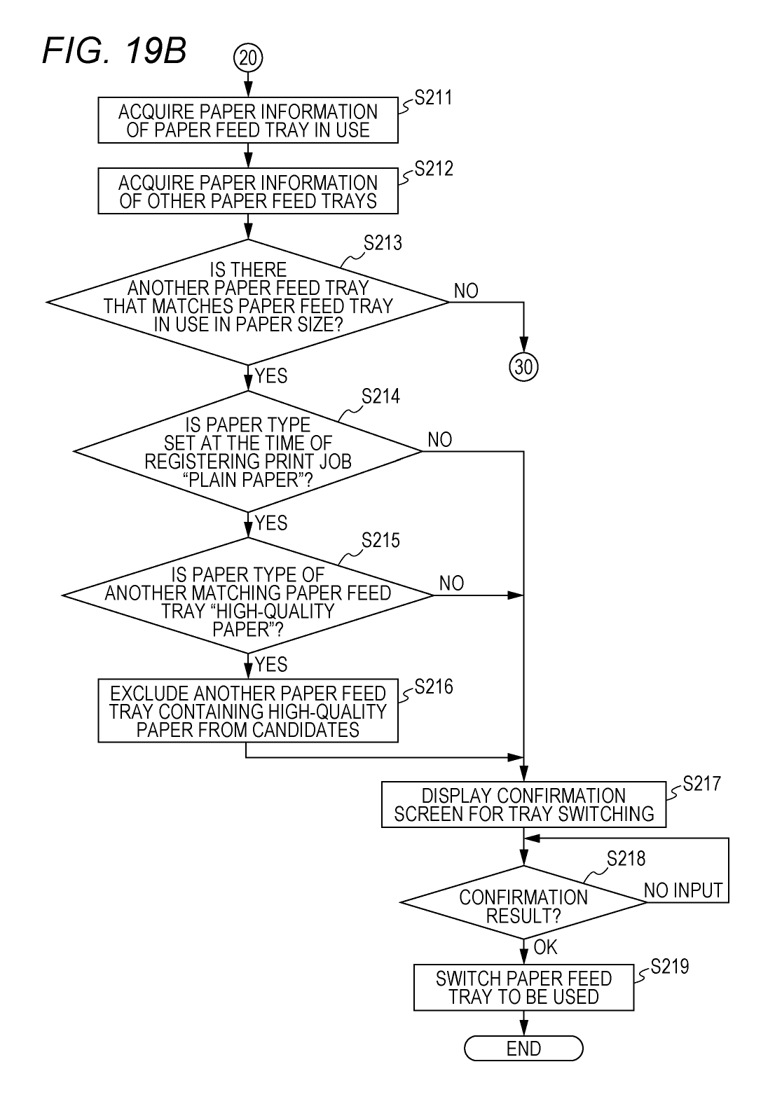

(Step S16 (Paper Feed Tray Switching Control)) FIGS. 19A and 19B are subroutine flowcharts for step S16 in FIG. 15. Here, as described below, ATS processing for paper feed trays is performed using the switching condition selected in step S15.

(Step S201)

First, if the switching condition selected in step S15 is the “first switching condition” for a user for PP (YES), the switching controller 110 advances the processing to step S202. If the switching condition selected in step S15 is not the first switching condition (NO) but the “second switching condition” for a user for OP, the switching controller 110 advances the processing to step S211 in FIG. 19B.

(Step S202)

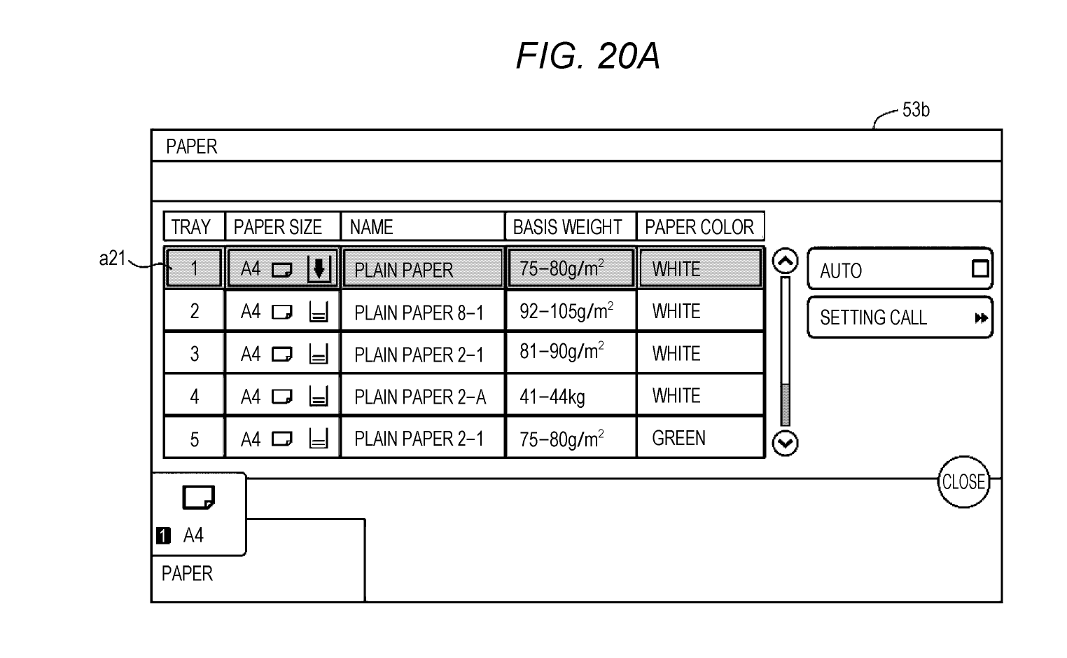

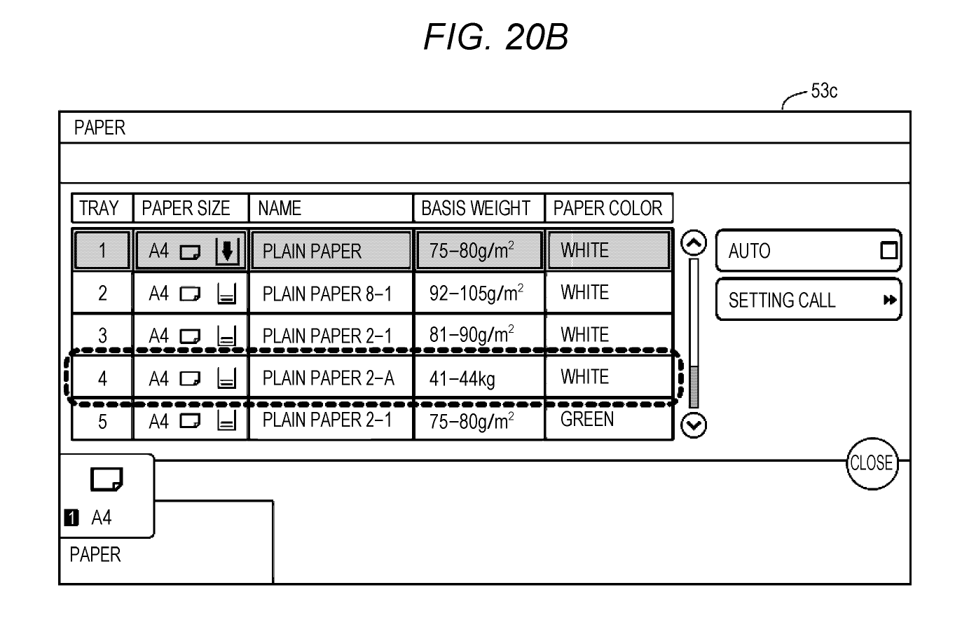

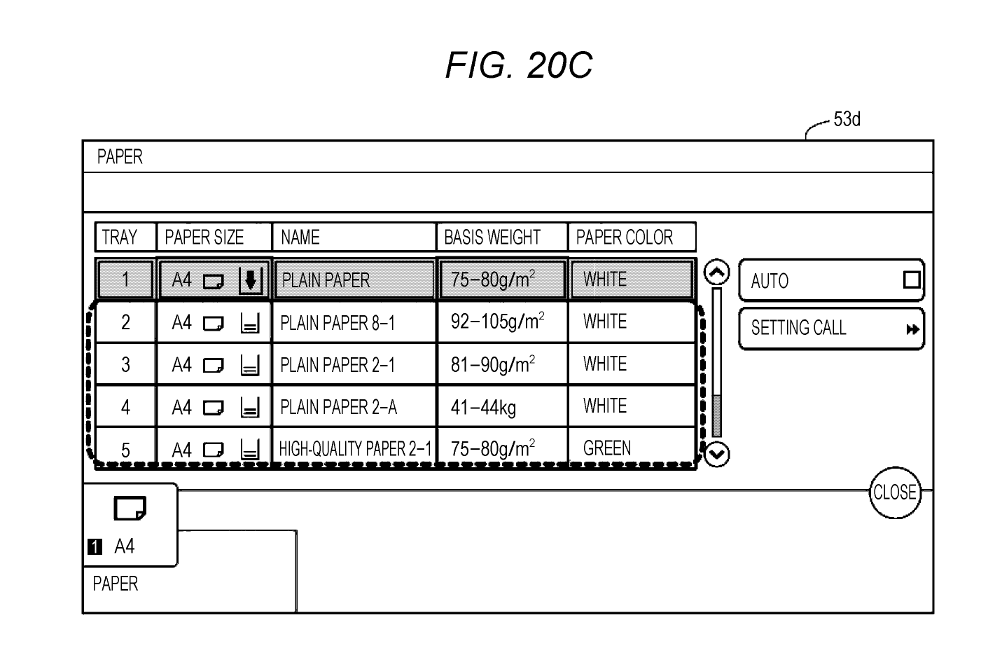

Here, the switching controller 110 acquires the paper information of the paper feed tray 31 in use. The acquired paper information includes paper size, basis weight (paper basis weight), and paper type. A setting screen 53b of FIG. 20A indicates that paper absence occurs in the uppermost “tray 1” (field a21) in use. Regarding the paper information of “tray 1”, the paper size is A4, the paper type is “plain paper”, the basis weight is 75-80 g/m², and the paper color is “white”. In the example illustrated in the figure, “paper type” and “paper color” are used as paper type information. However, paper type information may further include the presence/absence of “punch holes” and the availability of “index paper”. FIG. 21 is a table describing items related to paper information and classifications (classes) of each item.

(Step S203)

Next, the switching controller 110 acquires the paper information of the other paper feed trays 31. At this time, if there is a paper feed tray that cannot be used because no sheets S are stored, for example, paper information may not be acquired from that paper feed tray.

(Step S204)

The switching controller 110 compares the paper information of the paper feed tray 31 (tray 1) in use acquired in step S202 and the paper information of each of the other paper feed trays 31 (trays 2 to 5) acquired in step S203 in terms of the first switching condition. Here, the first switching condition is to determine whether all of the paper size, basis weight, and paper type of the paper information of the paper feed tray in use match those of another paper feed tray. If they match, switching to another paper feed tray is performed. In the example of FIG. 20B, tray 4 that matches tray 1 in all the items of paper information is selected. Although the unit systems of the basis weight of tray 1 and tray 4 are different, basis weight 41-44 kg (A1U kg) is equal to basis weight 75-80 g/m², and these basis weights belong to the same classification. Thus, it is determined that the basis weight of tray 1 and the basis weight of tray 4 are the same. If there is another paper feed tray 31 that satisfies the first switching condition (YES), the processing proceeds to step S205. If there is no other matching paper feed tray 31 (NO), the processing proceeds to step S206. Note that a perfect match in paper information means a match in all the items of paper information in FIG. 21. In a case where there are a plurality of other paper feed trays 31 whose paper information perfectly matches that of the paper feed tray in use, for example, the most downstream paper feed tray 31 nearest to the image former 20 may be selected according to a predetermined priority order.

(Step S205) After switching the paper feed tray 31 to be used to another paper feed tray 31, the switching controller 110 finishes the processing of the subroutine flowchart, returns to the main routine flowchart of FIG. 15, and restarts the print job interrupted due to the absence of paper.

(Step S206)

Here, the switching controller 110 displays a warning screen on the operation panel 50 in order to notify the user that there is no paper.

(Step S207)

The switching controller 110 waits until the user replenishes the empty paper feed tray 31 with sheets S. If the paper feed tray 31 is replenished with sheets and becomes available (YES), the processing proceeds to step S208.

(Step S208)

The switching controller 110 erases the warning screen displayed in step S206. Thereafter, the processing of the subroutine flowchart is ended, and the flow returns to the main routine flowchart of FIG. 15 to restart the print job interrupted due to the absence of paper.

(Steps S211 and S212)

Hereinafter, the processing for the case where the second switching condition is selected will be described. In steps S211 and S212 in FIG. 19B, the switching controller 110 acquires the paper information of the paper feed tray 31 in use and the paper information of the other paper feed trays 31 in the same manner as in the above-described steps S202 and S203.

(Step S213)

The switching controller 110 compares the paper information of the paper feed tray 31 (tray 1) in use acquired in step S211 and the paper information of each of the other paper feed trays 31 (trays 2 to 5) acquired in step S212 in terms of the second switching condition. Here, the second switching condition is to determine whether the paper size of the paper information of the paper feed tray in use matches that of another paper feed tray. If they match, switching to another paper feed tray is performed. In the example of FIG. 20C, all of trays 2 to 5 can be targets (candidates) for switching. If there is another paper feed tray 31 that satisfies the second switching condition, that is, if there is another paper feed tray 31 with the matching paper size (YES), the processing proceeds to step S214. If there is no other matching paper feed tray 31 (NO), the processing returns to step S206. If there is another paper feed tray 31 whose paper information perfectly matches that of the paper feed tray in use, this paper feed tray 31 may be selected, the subsequent steps S214 to S218 may be skipped, and the processing may proceed to step S219.

(Step S214)

The switching controller 110 determines whether the paper type of the paper feed tray 31 used at the time of registering the print job, that is, at the time of inputting the print job in step S11, and which has run out of paper is “plain paper”. If the paper type is “plain paper” (YES), the processing proceeds to step S215, otherwise (NO) the processing proceeds to step S217.

(Step S215)

Here, the switching controller 110 determines whether the paper type of the other paper feed tray 31 with the matching paper size determined in step S213 is “high-quality paper”. If the paper type is “high-quality paper” (YES), switching to this paper feed tray 31 is prohibited, and the processing returns to step S206. This is because high-quality paper is generally expensive. Prohibiting such switching prevents a user for OP from unintentionally using expensive high-quality paper while using plain paper without being conscious of the paper type. On the other hand, if the paper type is not “high-quality paper” (NO), the processing proceeds to step S217. The present embodiment describes “high-quality paper” as an example of a “specific type of paper” determined in advance. However, a specific type of paper may be additional printing paper, embossed paper, or the like instead of high-quality paper. A specific type of paper may be designated by the user through the operation panel 50.

(Step S216)

Here, the switching controller 110 excludes the paper feed tray 31 containing high-quality paper from the paper feed trays 31 determined in step S213. For example, in the examples illustrated in FIGS. 20A to 20C, the paper size of tray 5 matches that of the paper feed tray in use, but the paper type thereof is high-quality paper. Therefore, tray 5 is excluded, and trays 2 to 4 are left as candidates for switching. Then, the processing proceeds to step S217. Note that if there is no other paper feed tray 31 that satisfies the first switching condition as a result of excluding, the processing returns to step S206.

(Step S217)

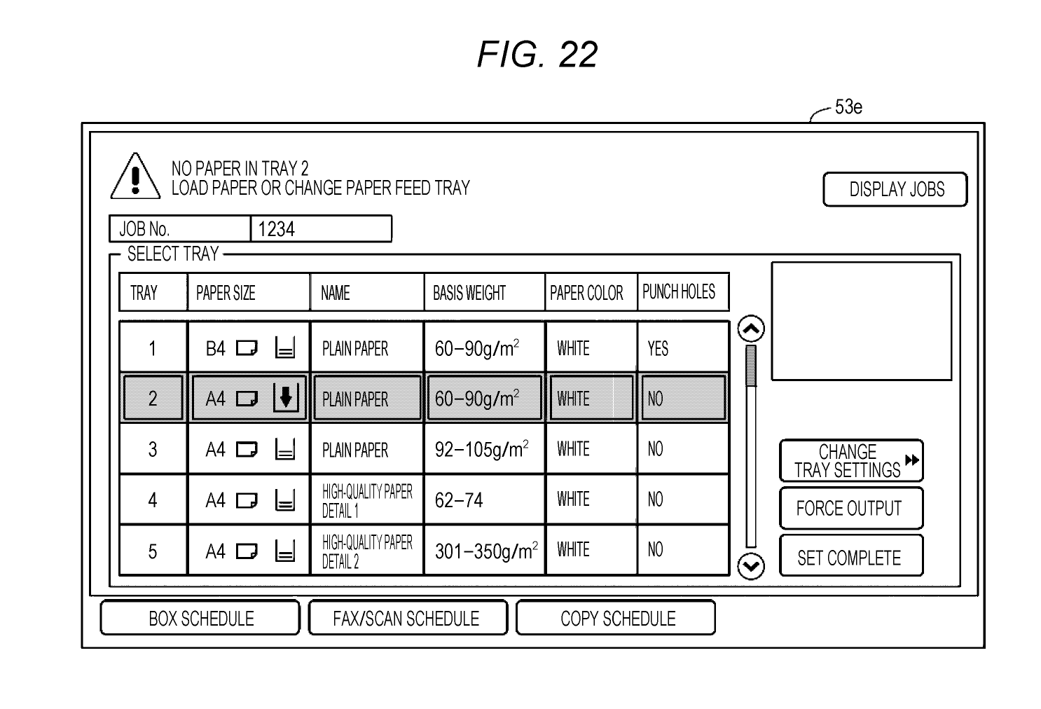

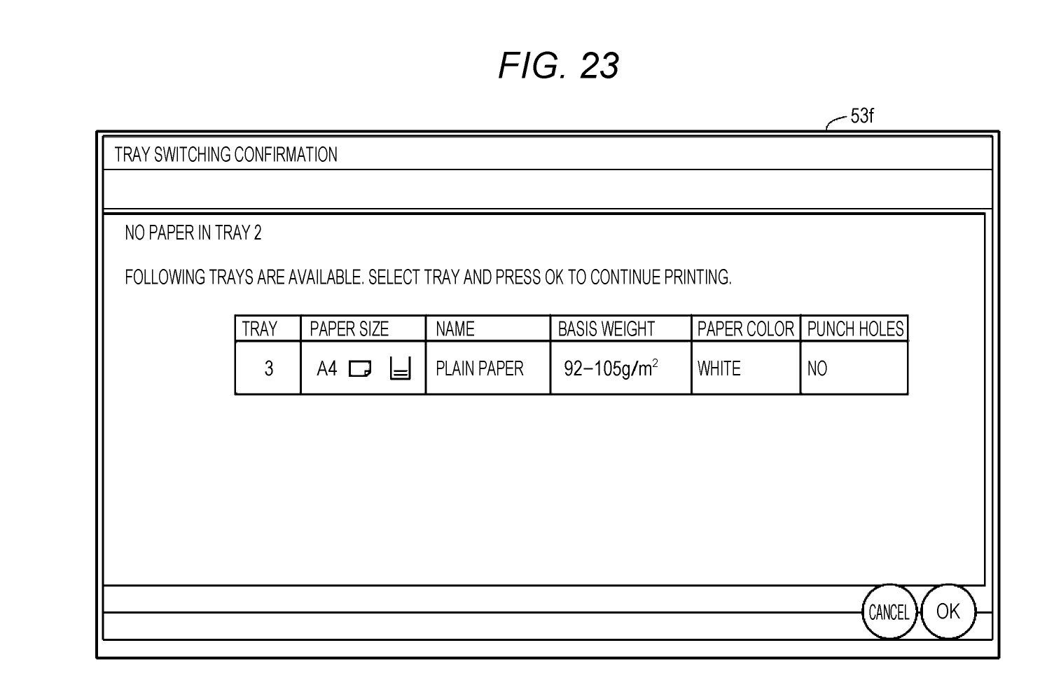

The switching controller 110 displays a confirmation screen for tray switching on the operation panel 50. FIGS. 22 and 23 are examples of confirmation screens 53e and 53f. In the example of the confirmation screen 53e of FIG. 22, the paper feed tray 31 used at the time of registering the print job and which has run out of paper is tray 2. The paper feed trays 31 that satisfy the second switching condition for tray 2 are trays 3 to 5. However, since trays 4 and 5 are excluded in step S216, tray 3 is designated as another paper feed tray 31 that is a target for switching.

A predetermined time after displaying the confirmation screen 53e of FIG. 22, the switching controller 110 displays the confirmation screen 53f of FIG. 23. On the confirmation screen 53f, all of the other target paper feed trays 31 are displayed. In the example of FIG. 23, however, the other target paper feed tray 31 is only tray 3.

(Step S218)

After selecting tray 3 in FIG. 22, the user can confirm the paper feed tray 31 for switching by pressing the “OK” button. The switching controller 110 waits for the user's operation on the confirmation screen 53f, and if the confirmation result is OK, the processing proceeds to step S219. The user can press the “cancel” button to cancel the switching to another paper feed tray. In this case, the switching controller 110 returns the processing to step S206.

(Step S219)

After switching the paper feed tray 31 to be used to the paper feed tray 31 confirmed by the user in step S218, the switching controller 110 ends the processing of the subroutine flowchart, returns to the main routine flowchart of FIG. 15, and restarts the print job interrupted due to the absence of paper.

(Case where Job Attribute is “Job Setting”)

Next, with reference to FIG. 16 again, the processing for the case of another job attribute will be described. When “job setting” is selected in the field all of the setting screen 53a of FIG. 17 in step S101 of FIG. 16, the subroutine flowchart of FIG. 24 below is executed.

(Step S301) In step S301 of FIG. 24, the switching controller 110 acquires the number of output copies and the number of pages per copy from the setting contents of the job setting of the print job that has caused paper absence during execution.

(Step S302)

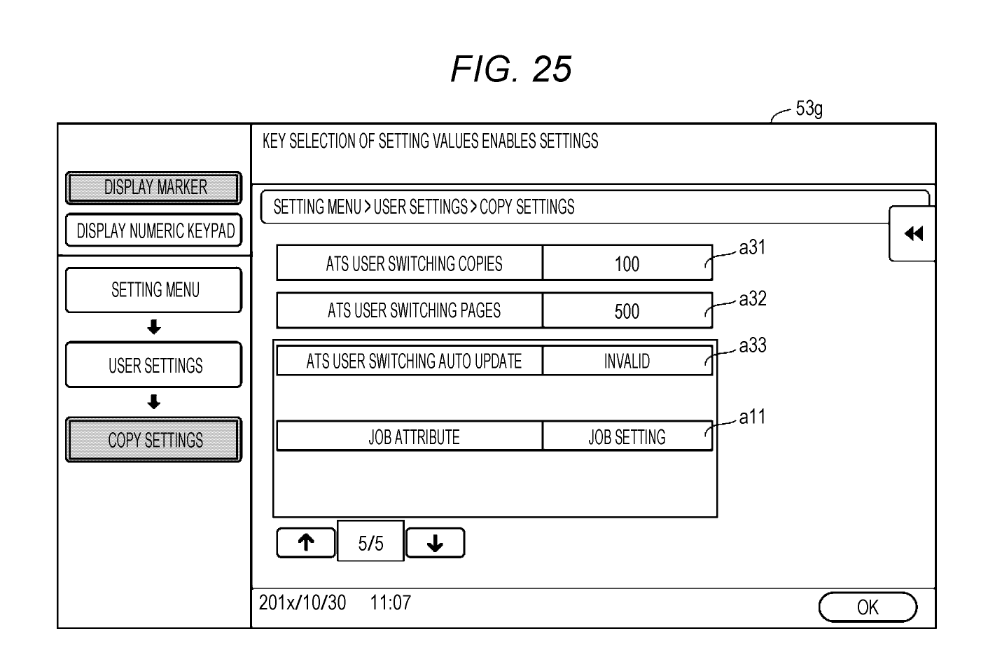

The switching controller 110 compares the number of output copies with a threshold value a and compares the number of pages per copy with a threshold value b. A setting screen 53g in FIG. 25 is a screen for the case where “job setting” is selected as the job attribute in the field all on the setting screen 53a in FIG. 17. By selecting the job setting in the field all, the user can set the threshold value a in the field a31 and the threshold value b in the field a32, respectively. Further, the automatic updating function to be described later is enabled in the field a33 (see FIG. 26 to be described later). These settings by the user are stored in the storage 130.

In the example of FIG. 25, 100 copies and 500 pages are set as the threshold value a and the threshold value b, respectively. If the number of output copies of the job setting of the print job exceeds the threshold value a or the number of pages per copy exceeds the threshold value b, the switching controller 110 advances the processing to step S303. On the other hand, if neither of them is satisfied, the processing proceeds to step S304. This is because if either of them exceeds the threshold value, the print job having such a job setting can be presumed to be a print job by a user for PP, and if neither of them is satisfied, the print job having such a job setting can be presumed to be a print job by a user for OP.

(Step S303)

The switching controller 110 selects the first switching condition. After that, the processing of the subroutine flowchart is ended, and the flow returns to the main routine flowchart of FIG. 15.

(Step S304) The switching controller 110 selects the second switching condition. After that, the processing of the subroutine flowchart is ended, and the flow returns to the main routine flowchart of FIG. 15.

(Step S17 (Print Job History Management))

Next, with reference to FIG. 26, the processing for print job history management will be described. FIG. 26 is a subroutine flowchart for step S17, which is performed after completion of the print job.

(Step S401)

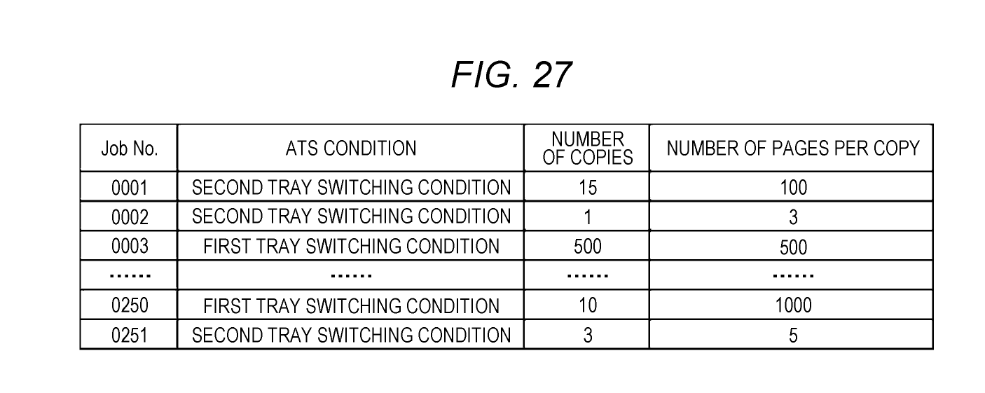

The analyzer 120 accumulates the setting information of the completed print job in the history data of the storage 130. This setting information includes the number of output copies printed and the number of pages per copy. FIG. 27 is an example of history data stored in the storage 130 of the controller 10.

(Step S402) If “valid” is set for automatic updating in the field a33 in FIG. 25 (YES), the analyzer 120 advances the processing to step S403. If “invalid” is set (NO), the analyzer 120 ends the processing of the subroutine flowchart.

(Step S403)

The analyzer 120 calculates (1) the average number of copies a and (2) the average number of pages per copy b from the history data stored in the storage 130.

(Step S404)

The analyzer 120 updates the threshold value a of the number of copies with the calculated average number of copies a.

(Step S405)

Similarly, the analyzer 120 updates the threshold value b of the number of pages per copy with the calculated average number of pages per copy b. The processing of FIG. 26 is thus ended, and the flow returns to the main routine flowchart of FIG. 15 and terminates the processing.

Averages are used in step S403 but need not necessarily be used. For example, as illustrated in FIG. 27, in the history data, the tray switching condition is determined for each print job regardless of the occurrence of paper absence, and the determined tray switching conditions are accumulated in the history data. Then, only the history data of the second tray switching condition are extracted, and the threshold value a is updated with the number of copies that slightly exceeds the maximum number of output copies thereof, for example, the maximum number of output copies plus a constant value. Similarly, the threshold value b is updated with the number of pages per copy that slightly exceeds the maximum number of pages per copy from the history data of the second switching condition. In this way, the threshold value a and the threshold value b may be updated.

As described above, in the present embodiment, in accordance with the setting of the selected job attribute, the job attribute of the issued print job is identified, and in accordance with the identified job attribute, the first tray switching condition for a user for PP or the second tray switching condition for a user for OP that is more lenient than the first tray switching condition is selected. In response to detecting the absence of paper in the paper feed tray in use during the execution of the print job, control is performed to switch to another paper feed tray that satisfies the selected tray switching condition. In this way, it is possible to execute the control of switching the paper feed tray according to the user who has issued the print job, thereby providing an image forming apparatus excellent in usability and a control program.

The above description provides the main configuration of the image forming apparatus 1 for explaining the features of the above-described embodiment. The configuration of the image forming apparatus 1 is not limited to the above configuration, and various modifications can be made within the scope of the claims. The above description does not exclude a configuration of a typical image forming apparatus.

In the description of the present embodiment, the three items “user information”, “setting screen type”, and “job setting” are selectively used as the “job attribute”. However, the present invention is not limited to this, and only one of them may be fixedly used. For example, only “user information” may be used as the “job attribute”. In FIG. 16, only steps S102 to S104 may be performed, and the other steps may be omitted.

In each flowchart, some steps may be omitted, or the order of steps may be changed. For example, the process of prohibiting the change to high-quality paper in steps S214 to S216 in FIG. 19B may be omitted, or the process of user confirmation in steps S217 and S218 in FIG. 19B may be omitted. Step S15 in FIG. 15 may be performed before step S14.

Means and methods for performing various processes in the image forming apparatus according to the above-described embodiment can be realized by either a dedicated hardware circuit or a programmed computer. The program may be provided by a computer readable recording medium such as a USB memory or a digital versatile disc (DVD)-ROM, or may be provided online via a network such as the Internet. In this case, the control program recorded on the computer readable recording medium is usually transferred to and stored in a storage such as a hard disk.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
a plurality of paper feed trays that feed accommodated sheets of paper;
a detector that detects absence of paper in the paper feed trays;
an image former that forms an image on a sheet of paper fed from one of the paper feed trays based on a print job; and
a hardware processor that identifies a job attribute of the print job issued, selects a first tray switching condition or a second tray switching condition that is more lenient than the first tray switching condition in accordance with the job attribute identified, and in response to the detector detecting absence of paper in the paper feed tray in use during execution of the print job, switches to another paper feed tray that satisfies the tray switching condition selected.

2. The image forming apparatus according to claim 1, wherein the hardware processor uses, as the job attribute, user information of a user who has issued the print job.

3. The image forming apparatus according to claim 2, wherein
user authentication is performed as the print job is issued, and
the hardware processor refers to a user list describing a correspondence relationship between user information and the tray switching conditions stored in advance, and selects the tray switching condition using user information of an authenticated user.

4. The image forming apparatus according to claim 1, wherein the hardware processor uses, as the job attribute, a type of setting screen used for setting paper information of the paper feed tray in use.

5. The image forming apparatus according to claim 4, wherein
the type of setting screen includes a first type setting screen that performs detailed settings regarding the paper information and a second type setting screen that is simpler than the first type setting screen,
the hardware processor switches to another paper feed tray according to the first tray switching condition when the paper information of the paper feed tray in use has been set using the first type setting screen, and
the hardware processor switches to another paper feed tray according to the second tray switching condition when the paper information of the paper feed tray in use has been set using the second type setting screen.

6. The image forming apparatus according to claim 1, wherein the hardware processor uses a job setting of the print job as the job attribute identified.

7. The image forming apparatus according to claim 6, wherein the hardware processor selects the first tray switching condition in a case where the number of copies or the number of pages per copy set in the job setting exceeds a predetermined threshold value, and selects the second tray switching condition in a case where neither the number of copies nor the number of pages per copy exceeds the threshold value.

8. The image forming apparatus according to claim 7, wherein the threshold value is settable by a user.

9. The image forming apparatus according to claim 7, wherein
the job setting of the executed print job is accumulated as history data,
the hardware processor analyzes the job setting of the history data, and sets the threshold value based on the number of copies of and the number of pages per copy in the history data.

10. The image forming apparatus according to claim 1, wherein the hardware processor compares a paper size, a basis weight, and a paper type of the paper feed tray in use and those of another paper feed tray as the first tray switching condition, and determines that the first tray switching condition is satisfied when all of these match.

11. The image forming apparatus according to claim 1, wherein the hardware processor determines that the second tray switching condition is satisfied when paper sizes of the paper feed tray in use and another paper feed tray match as the second tray switching condition.

12. The image forming apparatus according to claim 11, wherein in a case where the second tray switching condition is selected, even when the paper size of the paper feed tray in use whose paper type is plain paper matches the paper size of another paper feed tray whose paper type is a specific type of paper determined in advance, the hardware processor prohibits switching to the other paper feed tray.

13. The image forming apparatus according to claim 1, wherein the hardware processor displays a confirmation screen for accepting confirmation by a user when switching to another paper feed tray according to the second tray switching condition.

14. The image forming apparatus according to claim 1, wherein the hardware processor accepts settings of the job attribute by a user, and switches the job attribute to be used according to the accepted settings.

15. The image forming apparatus according to claim 14, wherein any one of:
user information of a user who has issued the print job;
a type of setting screen used for setting paper information of the paper feed tray in use; and
a job setting of the print job is selected as the job attribute.

16. A non-transitory recording medium storing a computer readable control program that is executed by a computer that controls an image forming apparatus including: a plurality of paper feed trays that feed accommodated sheets of paper; a detector that detects absence of paper in the paper feed trays; and an image former that forms an image on a sheet of paper fed from one of the paper feed trays based on a print job issued, the computer readable control program causing the computer to perform:
(a) detecting, by the detector, absence of paper in the paper feed tray in use during execution of the print job;
(b) identifying a job attribute of the print job issued;
(c) selecting a first tray switching condition or a second tray switching condition that is more lenient than the first tray switching condition in accordance with the job attribute identified; and
(d) switching to another paper feed tray that satisfies the tray switching condition selected.

17. The non-transitory recording medium storing a computer readable control program according to claim 16, wherein the (c) selecting includes selecting the tray switching condition using, as the job attribute identified, user information of a user who has issued the print job.

18. The non-transitory recording medium storing a computer readable control program according to claim 16, wherein the (c) selecting includes selecting the tray switching condition using, as the job attribute identified, a type of setting screen used for setting paper information of the paper feed tray in use.

19. The non-transitory recording medium storing a computer readable control program according to claim 16, wherein the (c) selecting includes selecting the tray switching condition using a job setting of the print job as the job attribute identified.
